(19) United States
(12) Patent Application Publication
(10) Pub. No.: US 2012/0298934 A1
(43) Pub. Date: Nov. 29, 2012

(54) TELESCOPIC STRUCTURE AND LIFTING SYSTEM

(75) Inventor: Cesar del Campo y Ruiz de Almodovar, El Puerto de Santa Maria (Cadiz) (ES)

(73) Assignee: GRUPO DE INGENIERIA OCENICA, S.L., TENERIFE-ISLAS CANARIAS (ES)

(21) Appl. No.: 13/514,605

(22) PCT Filed: Dec. 10, 2010
(86) PCT No.: PCT/ES2010/000507

§ 371 Date: Aug. 13, 2012

(30) Foreign Application Priority Data
Dec. 11, 2009 (ES) P200902314

(51) Int. Cl. B66F 7/14

(52) U.S. Cl. 254/92

(57) ABSTRACT

A telescopic structure formed by various bodies that are raised by a raising system which comprises a multitude of base pieces (3) which are joined to the outermost body (2) of the telescopic structure (1) to which some hydraulic telescopic and vertical cylinders are bolted (4) supported by the base pieces (3), with a cylinder being situated (4) on top of each base piece (3) and said cylinders being able to close in and move away from the structure (1) through some channels and some pieces (5) joined to some supporting elements (6) perpendicular to the wall of the structure, with said pieces being situated over the cylinders (4), in a way that on closing in on the cylinders of the structure, the supporting elements are introduced into the drills (7) corresponding to the body that is going to raise up and when the cylinder rises up, the corresponding body rises up.

### TECHNICAL SECTION OF THE INVENTION

This invention refers to a lifting system of a telescopic structure of large dimensions, which would be used, among many other uses, as a support for aerogenerators, especially those situated in the sea, which need to be elevated up to a height where they can be used for productivity, and the structure thus has to be lifted up.

### BACKGROUND OF THE INVENTION

Currently lifting systems for telescopic structures are based on the use of floating cranes in the case of sea installations, which as well as being very costly as much on land as at sea, have the added inconvenience of needing calm conditions in terms of wind or other breezes, to be able to carry out their function normally. If we consider that locations are selected for the frequency and intensity of winds, the days when the equipment cannot be used in these circumstances increase the expense of installing the sections of the towers and the aerogenerator. In the case of installations on land, the size of the cranes, makes it essential to create a network of channels, with sufficient steadiness, for access to each position, which makes the costs of installation go up even more.

In situations requiring the lifting of extremely large structures in a way that is cost-effective, safe and indifferent to meteorological conditions, as in the case of a telescopic structure for the intended use of supporting aerogenerators situated on the surface of the water, other alternative lifting methods are required.

For this, this invention has, as its objective, a new lifting system for large-scale telescopic structures where the structure is lifted in this way.

### DESCRIPTION OF THE INVENTION

The structure is made up of a multitude of units in a telescopic formation, with it being possible for these to be of any geometry [shape]. Or rather, we can have triangular, quadrangular, pentagonal structures etc.

The outermost section of the structure will be solely grounded by one foundation. Each section of the structure has a series of bores which will be necessary to lift the structure with the lifting system and others to secure the units to each other once they are lifted.

The lifting system is made up of a number of parts which we will refer to as the base parts. If the structure is seen as a polygonal structure with a defined number of edges, the number of parts will be equal to the number of edges of the main body of the structure. These base parts are bolted to the outermost body of the structure on the bores which are intended for this effect. The base parts are of the appropriate shape to enable them to be coupled or fitted on the outside of the outermost wall. If the body is not cylindrical and has edges, the base parts will be fitted on said edges, being bolted to both sides of these. In turn, each one of the base parts supports a vertical hydraulic and telescopic cylinder that can extend and retract from/to the structure via a set of channels that are actioned mechanically, sequentially and automatically.

On top of the piston, there is another part which is joined to some supporting elements, preferably pins, perpendicular to the wall of the structure.

The lifting system functions as follows:

Once the base parts are bolted to the outermost body of the telescopic structure, a part of the existing hydraulic cylinders, preferably half of them, if they are an even number, in alternate positions, are brought in close to the structure via channels, in a way in which the supporting elements are introduced into some drills in the innermost body of the structure which are intended for such purposes, and thus the telescopic hydraulic cylinders lift up the whole length, lifting one of the units, the innermost one of the structure. Following on from that, the alternate cylinders, which have remained low and separate, then close in and introduce their pins into the corresponding drills and they hold the section which is lifting up; at this moment, the cylinders that are lifted up, move away from the structure until the supporting elements disconnect and descend. As these cylinders descend, the rest of the other half of the hydraulic cylinders that are holding the section being lifted are lifting up, lifting one section plus the body. Now, the other group of cylinders close in on the structure to then introduce their pins into the corresponding drills to hold the body and thus do so successively until the body is raised up.

The sections of a tower can measure any number of metres, so the lifting of one single section demands numerous lifting operations, so the functioning scope of the piston will be smaller than the section of the tower.

Once each unit of the structure is lifted completely, said unit will be bolted to the other to keep it raised. For this, the sections of the structure have other drills bolted onto their surface. To avoid the bolts loosening due to air movement, vibrations or pressure, a series of Allen pins are used, all joined to each other by a metal bar, for example, made of steel, which at suitable distances has some hexagonal pins which are introduced into the hollows of the Allen heads and which are welded to the aforementioned bar by their ends to the structure, and thus they remain fixed, without risk of them turning or loosening, and through this the structure remains raised.

### DESCRIPTION OF THE FIGURES

To complete the description that is being carried out and with the objective of helping to achieve better understanding of the features of the invention, there is an accompanying diagram where, in an illustrative and non-limitative way, the following has been depicted:

FIG. 1: A overview of a four-section telescopic structure with one of the elements of the raising system.

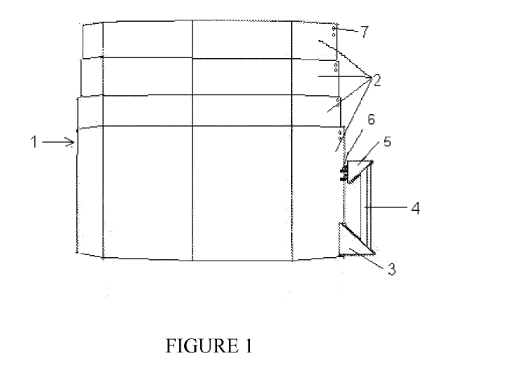

The references which appear in them are the following:
1.—Telescopic tower
2.—Body or section of the tower
3.—Base part
4.—Hydraulic telescopic cylinder
5.—Part joined with the supporting elements
6.—Pins
7.—Drills

### Ideal Description of how it Would Operate

To manage to have a better understanding of the invention, a description will now follow, with the help of the figures, of the raising system of a telescopic structure. The structure consists of a telescopic tower (1) made up of four units (2) with an octagonal geometry. Each unit in the tower has a multitude of drills (7) on both sides of each edge.

The raising system has eight base parts (3), each one of them supports its respective hydraulic cylinder (4) vertical and traversable by pathways. Each cylinder (4), in turn, supports its respective part (5) joined to four pins (6) which are perpendicular to the wall of the tower. The base parts (3) of the relevant geometry are fitted to the outer channel of the outermost body of the structure and are bolted onto said body (2). To elevate the first body (2), four of the telescopic hydraulic cylinders are used (4) which are found in alternate positions (we shall call these the A positions). When the telescopic cylinders (4) in the ‘A positions’ close in on the tower (1), the pins (6) are introduced into the drills (7) close to the innermost edge of the structure, so the telescopic hydraulic cylinders (4) rise up, raising the innermost unit of the structure. The elevation of one unit demands several raising operations, so the deployment of the hydraulic cylinder (4) will be less than that of the body of the tower.

The other four cylinders (4) in alternate positions (we shall call the the B Positions) close in and their pins are introduced (6) into some of the drills (7) to keep the body raised. When the body is (2) held up, the cylinders (4) in the A Positions move away from the structure and descend, whilst the cylinders (4) in the B positions which are holding up the raised body, rise up, raising another section of the body (2). The cylinders (2) in the A position close in on the structure once again, the pins (6) are introduced into the drills (7) and they hold up the body (2), while the cylinders (4) in B move away until the pins (6) come out and go down, and so on successively until each body is raised up completely.

Once each body has been lifted up (2), it bolts itself on to the other to keep itself raised up. For this, Allen pins are used with a hexagonal central head for bolting them in; to prevent vibrations loosening them, some pins are introduced into the hexagonal hollows in the heads identical to those of the piledriver joined to each other by a steel bar which is welded at points on the end of the structure.

1. A raising system for a telescopic structure (1) which possesses drills (7) in all parts of its structure which is comprised of the following elements:
A multitude of base parts (3) which are joined to the (2) outermost body of the telescopic structure (1) onto which they are bolted.
Some telescopic vertical hydraulic cylinders (4) supported by the base parts (3), with a cylinder situated (4) on top of each base part (3) and said cylinders being able to close in and move away from the structure (1) through pathways, with a sequential and automatic mechanical action.
Some parts (5) joined to some supporting elements (6) perpendicular to the wall of the structure, with said parts being situated on top of the cylinders (4), in a way that when the cylinders close in on the structure, the supporting elements are introduced into the drills (7) corresponding to the body that is going to rise up and elevate the cylinder, and the corresponding body is raised.

2. A system that in patent claim 1 is claimed because a part of the vertical telescopic hydraulic cylinders (4), preferably half of them, if they are an even number, and in alternate positions to the structure via the pathways, in a way that the supporting elements (6) are introduced to some drills (7) of the innermost body of the structure intended for such a purpose, then following that, the telescopic hydraulic cylinder (4) all of this rises up, raising a section of one of the bodies (2); following on from this, the rest of the hydraulic cylinders (4) that have not been involved in the raising up and that have stayed down and separate from the structure (1), close in on said structure (1) and introduce their supporting elements (6) into the corresponding taladros and hold up the body (2) that is rising up, in this moment thy cylinders (4) that are elevated, move away from the structure (2) until the supporting elements (6) disconnect themselves and go down; in a way that makes these cylinders (4) go down, and the rest or the other half of the hydraulic cylinders (4) raise themselves up, raising another section plus the body (2) and so on successively until the body (2) is completely raised.

3. The system according to patent claim 1, claimed because it is comprised of as many base pieces (3) as there are edges on the outermost body (2) of the structure (1), whenever the structure is not of a cylindrical shape.

4. The system according to patent claim 1 claimed because the horizontal supporting elements (6) are pins.

5. The telescopic structure (1) claimed by comprising of a raising system as described in patent claim 1.

6. The telescopic structure in patent claim 5 claimed because it can have any geometry, whether that may be rectangular, hexagonal, octagonal.

7. The telescopic structure according to patent claim 6 claimed because it has a series of drills (7) on all the bodies (2) of the structure that are used during the raising process.

8. The telescopic structure according to patent claim 7 claimed because its bodies (2) are kept raised up through a series of bolts joined to one another by a metallic bar to which Allen pins have been welded at a suitable distance and which are introduced into the hollows of the Allen heads; welding the ends of the bars to avoid the bolts being loosened by vibrations.
